(19) United States
(12) Patent Application Publication
(10) Pub. No.: US 2007/0239692 A1
(43) Pub. Date: Oct. 11, 2007

(54) LOGO OR IMAGE BASED SEARCH ENGINE FOR PRESENTING SEARCH RESULTS

(76) Inventor: Scott MCBRIDE, North Bay (CA)

Correspondence Address: SCHMEISER, OLSEN & WATTS, 22 CENTURY HILL DRIVE, SUITE 302, LATHAM, NY, 12110, US

(21) Appl. No.: 11/696,938

(22) Filed: Apr. 5, 2007

(30) Foreign Application Priority Data
Apr. 5, 2006 (CA) 2547800

(51) Int. Cl. G06F 17/30

(52) U.S. Cl. 707/3

(57) ABSTRACT

The present invention relates to a search engine which, in response to a search query, generates links to a set of documents relevant to the search query submitted by a user, associating an identifying logo for each of the generated links in the set of documents; and returning the generated links and the associated identifying logos to the user. An ordering component of the search engine embeds a hyperlink within the identifying logo or visual identifier for each of the generated links that are presented to the user, these logos or identifiers being miniaturized (“thumbnail”) renderings, that are ordered and presented in a visually concise manner on a singular document or page, for easy perusal by the user.

### FIELD OF THE INVENTION

The present invention relates generally to database search engines, and more particularly, to a visual Internet search engine that enables faster perusal of search engine results on a graphical level.

### DESCRIPTION OF THE PRIOR ART

The Internet or World Wide Web (“web”) contains a vast amount of information, and a search engine is a useful facility for browsing the Internet or World Wide Web. Search engines assist users in locating desired portions of this information by cataloging web documents, wherein, typically, in response to a user's request, the search engine returns references to documents relevant to the request. Examples of such conventional search engines include Google, Microsoft, Yahoo and Excite, to name but a few. Moreover, such conventional search engines generally filter and prioritize the search results providing a ranked listing based on: a) Keyword frequency and meta tags; b) Professional editors manually evaluating sites/directories; c) How much advertisers are prepared to pay, and d) Measuring which websites/webmasters think are important implemented by link analysis, which gives more weighting to sites dependent on what other sites are linked to them.

Search engines may also base their determination of the user's interest on search terms (called a search query) entered by the user. The goal of the search engine is to identify links to high quality relevant results based on the search query. Typically, the search engine accomplishes this by matching the terms in the search query to a quantity of pre-stored web documents. Web documents that contain the user's search terms are considered, “hits”, and are returned to the user.

However, with such a vast reservoir of information available to those accessing the Internet, it has become a difficult question as to how to find pertinent information on a textual search basis. Consequently, literal string searches are generally how information is retrieved or accessed on the Internet. One of the great drawbacks of current search engines is the output that they provide to the user. Often, such results are in the form of a list of hyperlinks with a cursory, if not cryptic, excerpt of initial text present on the web page, which is likely based upon the frequency of key words appearing in the documents searched, which may not be conducive to presenting the user with search results relevant and visually easily identifiable with their search queries.

There have been attempts to address this deficiency in the prior art. U.S. Pat. No. 6,643,641 (Snyder) described a search engine which utilizes a web crawler, whereby a user can, in addition seeing the literal search string text, also view a “snapshot” of a particular web page. However, the snap shot so provided is miniaturized, and as such, difficult to read. In addition, this feature is an option, which may or may not be used by the user. The search results themselves are still being presented in the form of a list of hyperlinks.

Thus, there is a need in the art to assist users in more effectively searching, by providing search results as recognizable company logos or like logos by which search results can be delivered to the user. It then becomes an easier task for the user to discriminate between those links that are of interest and those links which are not based upon the presentation of search results as graphical company logos or the like. To this end, the present invention effectively addresses this need.

### SUMMARY OF THE INVENTION

A general object of the present invention is to provide an improved and quicker review of search engine results and/or URL list information.

It is a further object of the present invention to provide an improved search engine which makes it easier for the user to discriminate between those links that are of interest and those links which are not, based upon the presentation of search results as graphical company logos or the like.

Yet another object of the present invention is to provide an improved search engine which maximizes the user's search time, and through which the user is able to more readily find those web pages of interest.

According to one aspect of the present invention, there is provided a method for performing a document search comprising generating links to a set of documents relevant to a search query submitted by a user; associating an identifying logo for each of the generated links in the set of documents; embedding a hyperlink within the identifying logo for each of the generated links in the set of documents; and returning the generated links and the associated identifying logos to the user.

According to another aspect of the present invention, there is provided a search engine comprising a search component configured to generate, from data files stored at distributed addresses on a data processing network, links to a set of documents relevant to a search query submitted by a user; an identification component for associating an identifying logo for each of the generated links in the set of documents; and an ordering component configured to return the generated links and the associated identifying logos to the user.

Yet another aspect of the present invention provides for a search engine configured to perform a document search in response to an input keyword submitted by a user, the search engine comprising input means arranged to receive the input keyword; searching means configured to generate, from data files stored at distributed addresses on a data processing network, links to a set of documents relevant to the input keyword submitted by a user; an identification component for associating an identifying logo for each of the generated links in the set of documents; and output means configured to return the generated links and the associated identifying logos to the user.

The advantage of the present invention is that it provides for an improved and quicker review of search engine results and/or URL list information.

Yet another advantage of the present invention is that it provides an improved search engine which makes it easier for the user to discriminate between those links that are of interest and those links which are not, based upon the presentation of search results as graphical company logos or the like.

A still further advantage of the present invention is that it provides an improved search engine which maximizes the user's search time, and through which the user is able to more readily find those web pages of interest.

### BRIEF DESCRIPTION OF THE DRAWINGS

A preferred embodiment of the present invention is described below with reference to the accompanying drawings, in which:

FIG. 1 is an exemplary diagram of a network in which the present invention may be implemented;

FIG. 2 is a continuation of FIG. 1, which illustrates further the server and search engine components in relation to the network;

FIG. 3 is a flow chart illustrating operation of a search engine consistent with an aspect of the present invention; and

FIG. 4 is a diagram illustrating an example of returned search results provided to a user for a possible search for the heading “NHL™ hockey teams”, or “professional hockey teams”, presented on a mobile telephone such as an I-phone.

### DESCRIPTION OF THE PREFERRED EMBODIMENT

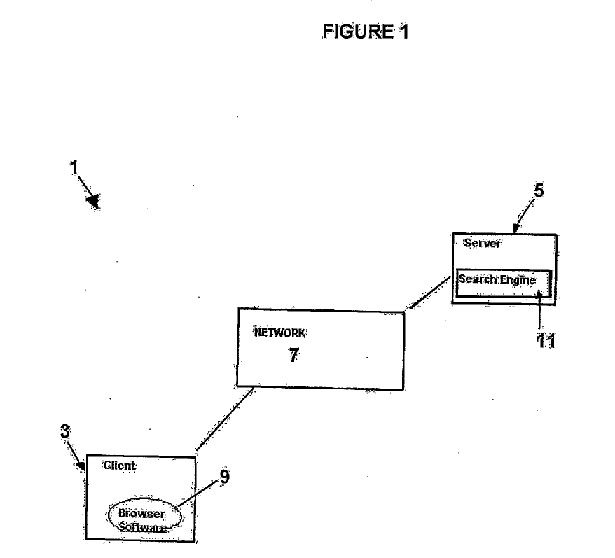

FIG. 1 is a diagram of a network 1 in which systems and methods consistent with the principles of the invention may be implemented, which may include a plurality of clients 3 connected to one or more servers 5 via a network 7, it being understood that network 7 may include a local area network (LAN), a wide area network (WAN), a telephone network, such as the Public Switched Telephone Network (PSTN), an intranet, the Internet, or a combination of networks, as would be apparent to one skilled in the art. In the example shown in FIG. 1, one client 3 and one server 5 have been illustrated as connected to network 7 for simplicity, though, in practice, there may be more or fewer clients and servers, it also being understood that a client may perform the functions of a server and a server may perform the functions of a client.

It will be understood that clients 3 will be utilizing client devices (not shown), which may include a wireless telephone, a personal computer, a personal digital assistant (PDA), a lap top, or another type of computation or communication device, a thread or process running on one of these devices, and/or an object executable by one of these devices. Such client devices will each include a computer-readable medium, such as random access memory, coupled to a processor, for executing program instructions stored in memory, as would be readily apparent to one skilled in the art. Client devices may also include a number of additional external or internal devices, such as, without limitation, a mouse, a CD-ROM, a keyboard, and a display. Of course, through client devices, clients 3 can communicate over network 7, and with other systems and devices coupled to network it will also be understood that such communication over network 7 can be effected using, for example, a computer, a web enabled television, a mobile telephone (such as an I-phone™), or a hand held computer.

Clients 3 may include client software, such as browser software 9. Browser software 9 may include a web browser, such as the existing Microsoft Internet Explorer or Netscape Navigator browsers. For example, when network 7 is the Internet, clients 3 may navigate the Internet by way of browsers 9 and, in particular, access server 5 via browsers 9.

Server 5 may operate as a web server and include search engine 11. In one implementation, search engine 11 may function as a query-based web page search engine. In response to client requests, search engine 11 may return sets of documents to clients 3. The documents may be returned to clients 3 as a web page containing a list of links to web pages that are relevant to the search query. This list of links may be ranked and displayed in an order based on the search engine's determination of relevance to the search query.

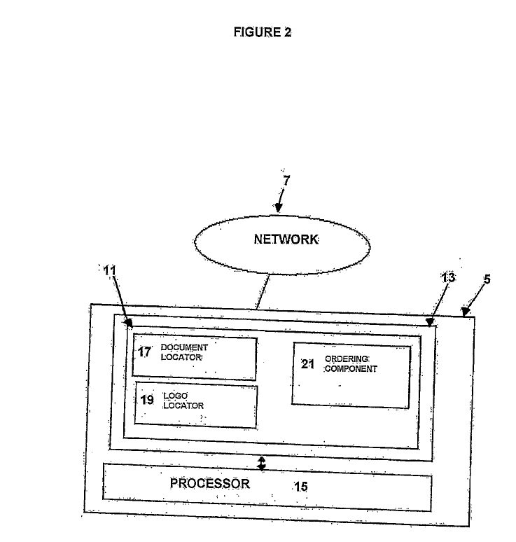

Similar to the client devices noted above, and as noted in FIG. 2, server 5 may include a processor 15 coupled to a computer-readable memory 13, it being understood that server 5 may additionally include a secondary storage element, such as a database, as would be apparent to one skilled in the art. Client processors (not shown) and server processor 15 can be any of a number of well known computer processors. In general, client devices may be any type of computing platform connected to a network and that interacts with application programs, such as a digital assistant or a “smart” cellular telephone or pager. It will be understood that server 5, although depicted as a single computer system in FIG. 1, may be implemented as a network of computer processors, as would be apparent to one skilled in the art.

Search engine 11 locates relevant information in response to search queries from clients 3. In particular, clients 3 send search queries to server 5, which responds by returning a list of relevant information to client 3. Typically, clients 3 ask server device 5 to locate web pages relating to a particular topic and stored at other devices or systems connected to network 7. Search engine 11 includes document locator 17, a logo or image locator 19 and a ordering component 21. In general, document locator 17 finds a set of documents whose contents match a user search query, and the logo or image locator 19 locates a corresponding company, institutional or brand logo, or other visual identifier, pertaining to that document. When performing a search for documents related to a user search query, search engine 11 may search documents gathered from resources coupled to network 7 (ie: web documents or Internet documents), it being understood that documents, as the term is used herein, is to be broadly interpreted to include any machine-readable and machine-storable work product. A document may be an e-mail, a file, a combination of files, one or more files with embedded links to other files, a news group posting, a web advertisement, or the like. In the context of the Internet, a common document is a web page. Of course, web pages often include textual information and may include embedded information (such as meta information, images, hyperlinks, etc.) and/or embedded instructions (such as Javascript, etc.).

Ordering component 21 may rank the located set of documents based on relevance and may generate a relevance score for each document that indicates a level of relevance. Ordering component 21 assists search engine 11 in returning relevant documents to the user by placing in order and ranking the set of documents identified by document locator 17 and the logo or image locator 19. This ranking may take the form of assigning a numerical value, such as a pertinency score, corresponding to the calculated relevance of each document identified by document locator 17. There are a number of suitable ranking algorithms known in the art, and, as such, will not be described further herein.

In a preferred embodiment, the ordering component 21 also embeds a hyperlink within the identifying logo or visual identifier for each of the generated links in the documents, the component being configured to return the generated links and the associated identifying logos and visual identifiers to the user. Search engine 11 may then return a list of links (a hyperlink embedded in the logo or visual identifier) to the user, pointing to each of the set of documents determined by document locator 17. The list of links may, of course, be sorted based on the relevance scores determined by ordering component 21. In an alternative embodiment, the ordering component 21 returns both a hypertext generated link in combination with the logo or visual identifier for that link. It will, of course, be understood that the ordering component can be arranged to return the identifying logos/visual identifiers to the user in a plurality of file formats, such as GIF, JPEG, TIFF, HTML, and other formats, as would be apparent to one skilled in the art. It will also be readily understood that these formats will be appropriate to be displayed on a personal computer, a web television, a mobile phone or a hand held computer or any combination of the aforesaid formats.

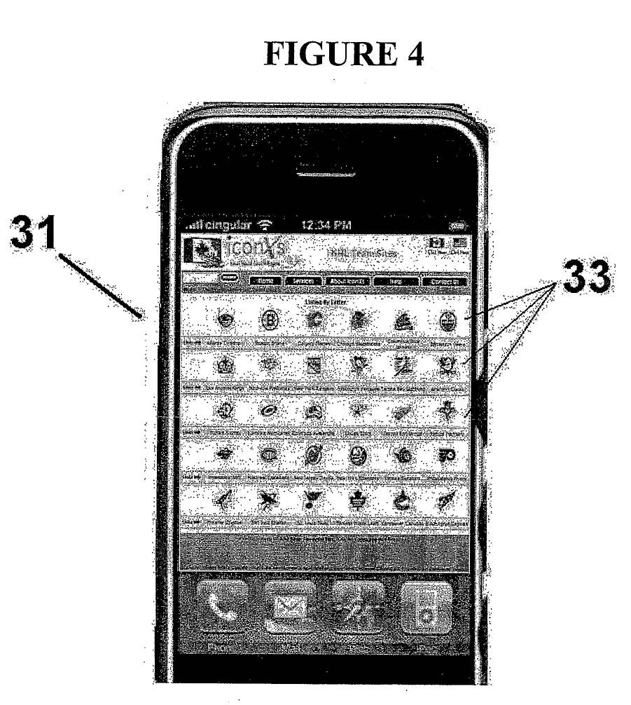

Of course, such logos and visual identifiers will preferably be of a size which is scale reduced, such as a thumbnail representation, whereby the ordering component can, in generating a document (such as a web page) that contains the results of the search query, organize the logos and visual identifiers located during the search in a visually concise manner. Preferably, the search results will be ordered and presented on a singular document or page. As an example, and with reference to FIG. 4, which illustrates an example of returned search results provided to a user for a possible search for the heading “NHL™ hockey teams”, or “professional hockey teams”, one or more of the search generated links are embedded within a logo or visual cue, or is closely associated with the link. In this example, it can be seen that these logos/visual cues are miniaturized (“thumbnails”) renderings of NHL™ team logos, and are ordered and presented in a visually concise manner on, preferably, a singular document or page though it will also be understood that, when the search results returned are extensive, that multiple pages may be required to present such search results. In the example shown in FIG. 4, the returned search results with each of these logos 33 are presented on a mobile telephone 31 (such as an I-phone™).

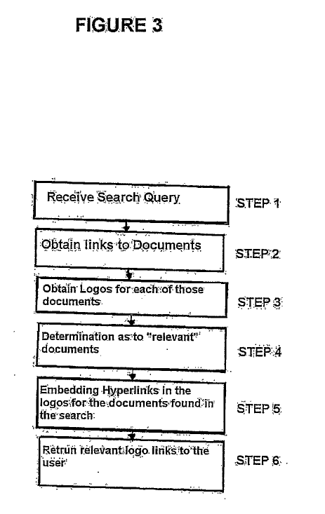

FIG. 3 is a flow chart illustrating operation of a search engine 11 consistent with one aspect of the present invention. Search engine 11 may begin by receiving a search query a user (Step 1). Based on the search query, document locator 17 of the search engine may obtain and generate a set of links to documents that are relevant to the search query (Step 2). Next, the logo or image locator 19 locates a corresponding company, institutional or brand logo, or other visual identifier, pertaining to that document (Step 3). The set of links may then be sorted by the ordering component 21 based on suitable ranking algorithms for each of the documents and logos associated therewith (Step 4), whereby the ordering component 21 then determines whether any of the links returned by document locator 17 (and logos returned by the logo or image locator 19) are “relevant” documents. The ordering component 21 also embeds a hyperlink within the identifying logo or visual identifier for each of the generated links in the documents. (Step 5), the search results then being returned to the user that entered the search query as a set of links to the user (Step 6).

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code, it being understood that a person of ordinary skill in the art would be able to design software and control hardware to implement the aspects based on the description herein.

The present invention has been described herein with regard to preferred embodiments. However, it will be obvious to persons skilled in the art that a number of variations and modifications can be made without departing from the scope of the invention as described herein.

1. A method for performing a document search comprising:
generating links to a set of documents relevant to a search query submitted by a user;
associating an identifying logo for each of the generated links in the set of documents;
embedding a hyperlink within the identifying logo for each of the generated links in the set of documents; and
returning the generated links and the associated identifying logos to the user.

2. The method of claim 1, wherein the identifying logo for each of the generated links is returned to the user as a thumbnail representation of that identifying logo.

3. The method of claim 2, wherein the thumbnail representations of the identifying logos for each of the generated links are organized and condensed for the user in a generated document.

4. The method of claim 3, wherein the generated document is a web page.

5. The method of claim 2, wherein the thumbnail representations of the identifying logos for each of the generated links are visually organized and condensed for the user on a singular web page.

6. The method of claim 1, wherein the hyperlink is a hyper-text transfer protocol (HTTP) link.

7. The method of claim 1, wherein the generated links and the associated identifying logos are visually organized and condensed for the user on multiple web pages.

8. A search engine comprising:
a search component configured to generate, from data files stored at distributed addresses on a data processing network, links to a set of documents relevant to a search query submitted by a user;
an identification component for associating an identifying logo for each of the generated links in the set of documents; and
an ordering component configured to return the generated links and the associated identifying logos to the user.

9. The search engine of claim 8, wherein the ordering component returns the identifying logo for each of the generated links to the user as a thumbnail representation of that identifying logo.

10. The search engine of claim 9, wherein the ordering component organizes and condenses for the user the thumbnail representations of the identifying logos for each of the generated links in a generated document.

11. The search engine of claim 10, wherein the ordering component returns the generated document to the user as a web page.

12. The search engine of claim 11, wherein the hyperlink is a hyper-text transfer protocol (HTTP) link.

13. The search engine of claim 11, wherein the data processing network is a local area network (LAN), a wide area network (WAN), a telephone network, an intranet, the Internet, or a combination of networks.

14. The search engine of claim 13, wherein the telephone network is a Public Switched Telephone Network (PSTN).

15. The search engine of claim 11, wherein the ordering component, prior to the identifying logos for each of the generated links being returned to the user, further determines whether one or more documents in the set of documents is likely to be a document that the user considers relevant to the search query.

16. The search engine of claim 11, wherein the generated links and the associated identifying logos are visually organized and condensed for the user on multiple web pages.

17. A search engine configured to perform a document search in response to an input keyword submitted by a user, the search engine comprising:
input means arranged to receive the input keyword;
searching means configured to generate, from data files stored at distributed addresses on a data processing network, links to a set of documents relevant to the input keyword submitted by a user;
an identification component for associating an identifying logo for each of the generated links in the set of documents; and
output means configured to return the generated links and the associated identifying logos to the user.

18. The search engine of claim 17, wherein said input means is a computer, a web enabled television, a mobile telephone or a hand held computer.

19. The search engine of claim 17, wherein the output means is arranged to return the associated identifying logos to the user in a plurality of formats.

20. The search engine of claim 19, wherein the formats are appropriate for a personal computer, a web television, a mobile phone or a hand held computer or any combination of the aforesaid formats.
